(19) United States
(12) Patent Application Publication
(10) Pub. No.: US 2026/0205790 A1
(43) Pub. Date: Jul. 16, 2026

(54) UE BEHAVIOR WHEN EMERGENCY SERVICES FALLBACK PROCEDURE FAILS DUE TO 5GS NETWORK AUTHENTICATION FAILURE

(71) Applicant: MediaTek Singapore Pte. Ltd., Singapore (SG)

(72) Inventors: Puneet ., Bengaluru (IN); Marko NIEMI, Oulu (FI)

(73) Assignee: MediaTek Singapore Pte. Ltd., Singapore (SG)

(21) Appl. No.: 19/473,947

(22) PCT Filed: Sep. 29, 2024
(86) PCT No.: PCT/CN2024/122208

§ 371 Date: Oct. 9, 2025

(30) Foreign Application Priority Data
Oct. 3, 2023 (IN) 202321066164
Oct. 3, 2023 (IN) 202321066165

(51) Int. Cl. H04W 4/90

(52) U.S. Cl. CPC H04W 4/90

(57) ABSTRACT

In an aspect of the disclosure, a method, a computer-readable medium, and an apparatus are provided. The apparatus may be a UE. The UE performs a procedure for emergency services fallback. The UE receives an AUTHENTICATION REJECT message from a network during the first procedure. The UE performs generic actions for authentication rejection by the network. These generic actions may involve updating the UE's internal state and clearing certain security parameters to maintain network integrity.

### CROSS-REFERENCE TO RELATED APPLICATION(S)

This application claims priorities of Indian Patent Application Serial No. 202321066164, entitled “A METHOD TO DEFINE UE BEHAVIOR WHEN EMERGENCY SERVICES FALLBACK IS FAILED DUE TO AUTHENTICATION FAILURE” and filed on Oct. 3, 2023, and Indian Patent Application Serial No. 202321066165, entitled “A METHOD TO DEFINE UE BEHAVIOR WHEN EMERGENCY SERVICES FALLBACK IS FAILED DUE TO AUTHENTICATION FAILURE” and filed on Oct. 3, 2023; both of which are expressly incorporated by reference herein in their entirety.

### BACKGROUND

### Field

The present disclosure relates generally to communication systems, and more particularly, to techniques of handling authentication failures during emergency services fallback procedures in mobile networks.

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE performs a procedure for emergency services fallback. The UE receives an AUTHENTICATION REJECT message from a network during the first procedure. The UE performs generic actions for authentication rejection by the network. These generic actions may involve updating the UE's internal state and clearing certain security parameters to maintain network integrity.

In another aspect of the disclosure, a method, a computer-readable medium, and an apparatus are provided. The apparatus may be a UE. The UE performs a procedure for emergency services fallback. The UE encounters authentication failures due to the UE deeming that a network has failed an authentication check. The UE performs generic actions for authentication failure. These actions may involve updating the UE's internal state and clearing certain security parameters to maintain network integrity.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating techniques for handling authentication failures during emergency services fallback procedures in mobile networks.

FIG. 8 is a flow chart of a method for wireless communication for handling network authentication rejections during an emergency services fallback procedure.

FIG. 9 is a flow chart of a method for handling authentication failures during an emergency services fallback procedure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

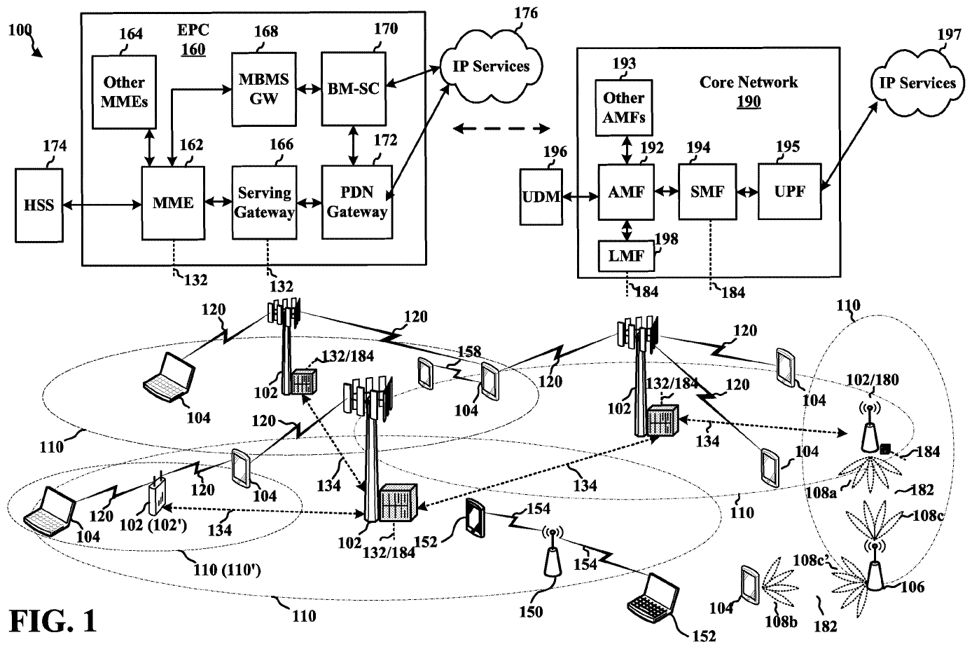

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′may have a coverage area 110′that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHZ unlicensed frequency spectrum. When communicating in an unlicensed frequency spectrum, the STAs 152/AP 150 may perform a clear channel assessment (CCA) prior to communicating in order to determine whether the channel is available.

The small cell 102′may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mm W frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW/near mmW radio frequency band (e.g., 3 GHz- 300 GHz) has extremely high path loss and a short range. The mm W base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

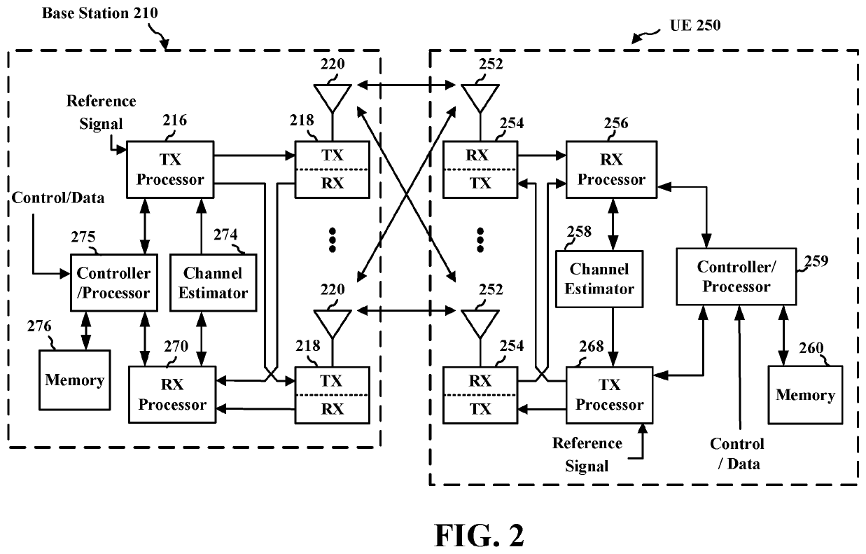

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

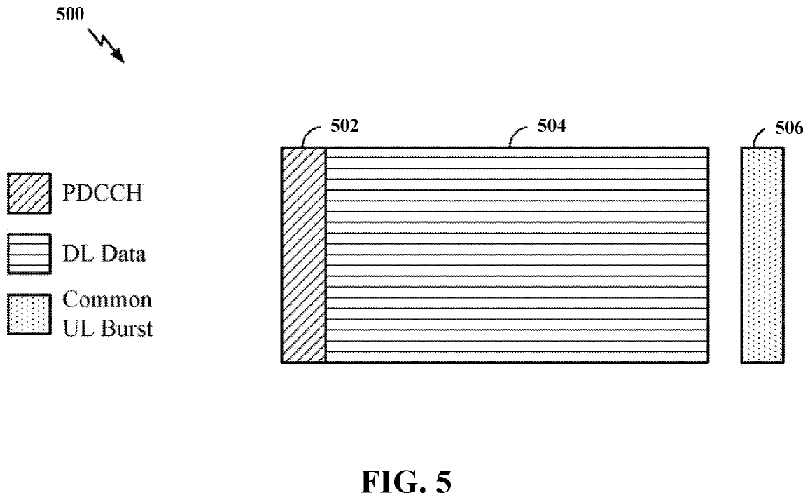

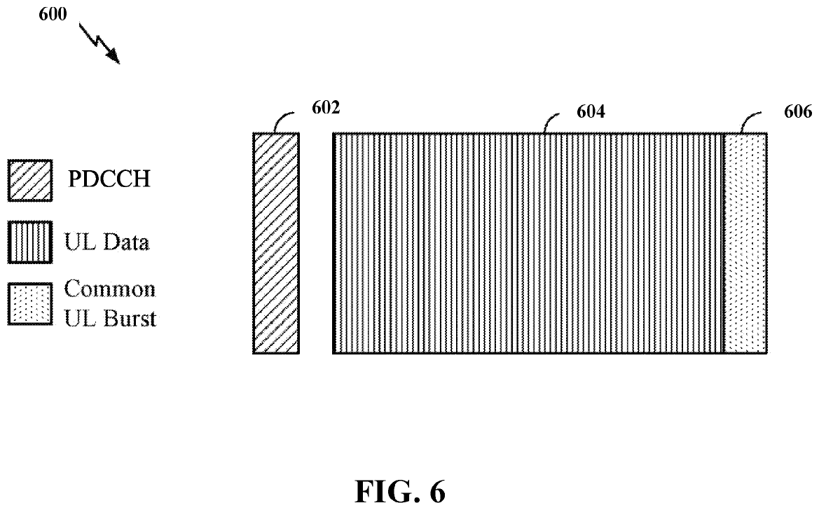

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

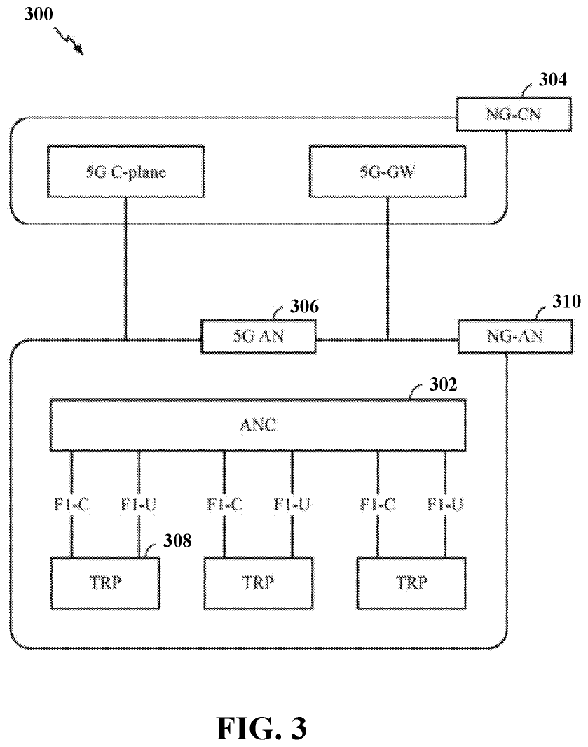

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

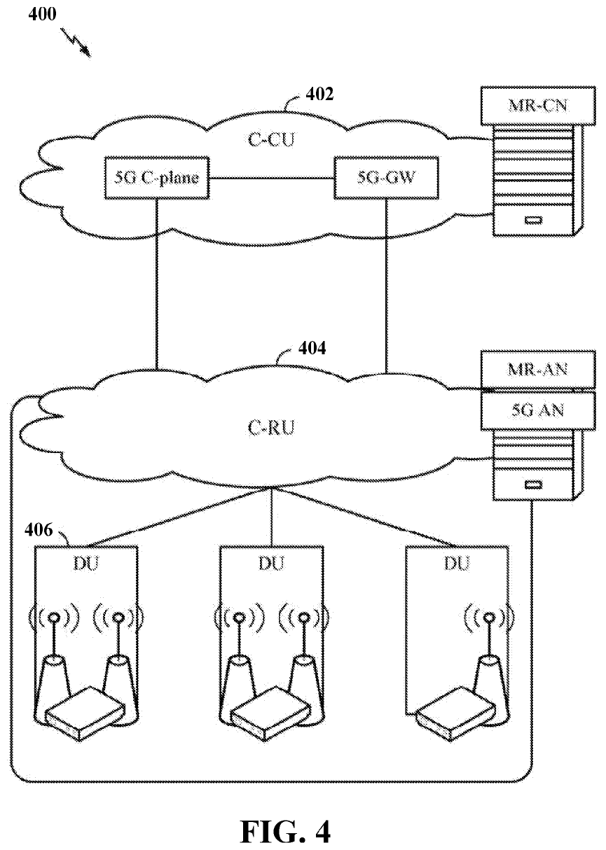

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The present disclosure addresses authentication failures in emergency services fallback scenarios in mobile networks, particularly focusing on the transition between 5G (5GS) and 4G (EPS) systems. Emergency Services Fallback (ESF) refers to the process where a User Equipment (UE) transitions from 5GS (N1 mode) to EPS (S1 mode) for emergency services when necessary.

The ESF process is initiated under specific conditions. When the 5G Core Network indicates support for ESF in the current Tracking Area (TA) and Radio Access Technology (RAT), and the UE also supports this feature, the UE may initiate the ESF procedure for emergency session establishment.

In scenarios where the UE has a pending IMS emergency session request from its upper layers, it communicates this need to the network. The UE does this by sending either a Service Request message or a Registration Request message. In the latter case, the 5GS registration type Information Element (IE) is set to “mobility registration updating,” explicitly indicating the requirement for emergency services fallback.

The actual fallback process from 5GS to EPS can occur in two primary ways, depending on the network configuration. When the N26 interface (which connects the 5G AMF to the 4G MME) is supported, the UE performs a Tracking Area Update (TAU) procedure with the active flag set to ‘1’. This flag indicates to the network that the UE has pending data to send, requesting immediate resource allocation for the emergency service.

In cases where the N26 interface is not supported, the fallback process is slightly different. The UE performs an ATTACH procedure, which is a more comprehensive registration process in EPS. Additionally, it sends a PDN (Packet Data Network) connectivity request with the type set as “handover.” The UE can establish the necessary data connection in EPS for the emergency service, maintaining continuity from the 5G network.

However, the ESF procedure can face challenges, particularly related to authentication failures. These procedures involve mutual authentication between the UE and the network, establishing key agreements like 5G AKA in 5GS or EPS AKA in EPS.

In 5GS, during service request and mobility registration update procedures, a 5G Authentication and Key Agreement (AKA) based primary authentication is performed. This process establishes mutual authentication between the UE and the network, and agrees on key materials KAUSF, KSEAF, and KAMF. While the network initiates and controls this procedure, both the UE and the network have the ability to reject the authentication if discrepancies are detected.

The UE may deem that the network has failed the authentication check or that the authentication is not genuine under specific circumstances. These include the expiration of timer T3520, or if the UE detects a combination of authentication failures such as MAC failure, synchronization failure, non-5G authentication unacceptable, or ngKSI already in use. These failures must occur during three consecutive authentication challenges while the T3520 timer is running to be considered a network authentication failure.

Similarly, in EPS, during EMM attach request and tracking area update procedures, an EPS AKA procedure is performed for mutual authentication and to agree on the KASME key. The process mirrors that of 5GS, with the network initiating and controlling the procedure, but both parties capable of rejecting the authentication if necessary.

In EPS, the UE considers the network to have failed the authentication check if timer T3418 or T3420 expires, or if it detects a combination of authentication failures (MAC failure, synchronization failure, or non-EPS authentication unacceptable) during three consecutive authentication challenges. These challenges are considered consecutive if they occur while the T3418 or T3420 timer, started after the previous authentication failure, is still running.

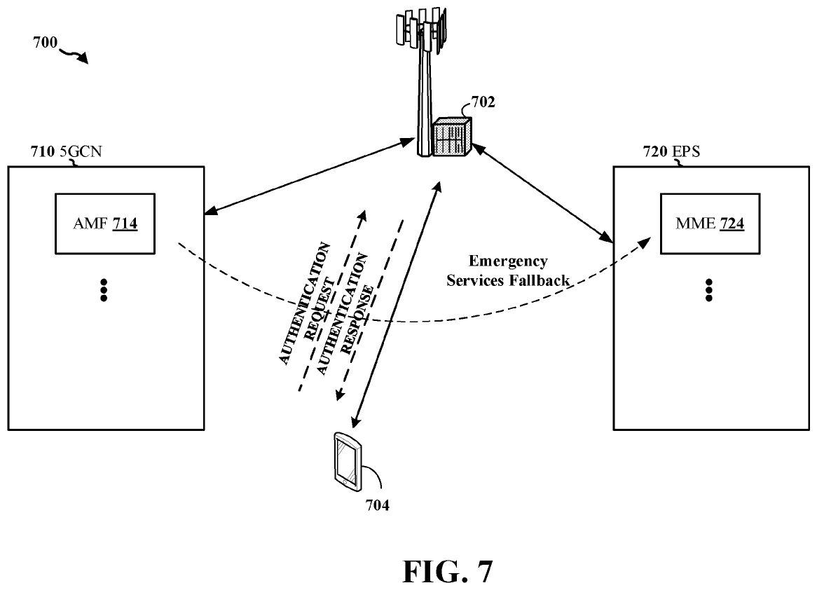

FIG. 7 is a diagram 700 illustrating techniques for handling authentication failures during emergency services fallback procedures in mobile networks. The diagram depicts the UE 704 initially camped on an E-UTRA or NR cell provided by a base station 702. This base station 702 is connected to both a 5G Core Network (5GCN) 710 and an Evolved Packet System (EPS) 720, representing the coexistence of 5G and 4G networks.

The Access and Mobility Management Function (AMF) 714 in the 5GCN 710 may indicate, to the UE 704, support for emergency services using fallback by the 5GCN 710.

In certain scenarios, the UE 704 may need to initiate an Emergency Services Fallback (ESF) procedure. For example, the ESF procedure is triggered when the UE 704 has a pending IMS emergency session request from its upper layers. The ESF allows the UE 704 to transition from 5G (N1 mode) to 4 G (S1 mode) for emergency services when necessary.

The UE 704 sends a Service Request message to the AMF 714, explicitly stating its requirement for emergency services fallback.

Upon receiving this request, the 5GCN 710 initiates the ESF procedure. The AMF 714 executes an NG-AP procedure, signaling to the base station 702 (NG-RAN) that a fallback for emergency services is required. Based on the support for Emergency Services in the EPS 720 and 5GCN 710, the AMF 714 may indicate the target Core Network (CN) to the base station 702. This information helps the base station 702 determine whether to perform an inter-RAT fallback or an inter-system fallback.

The base station 702, based on the target CN indication or its own configuration, then initiates either a handover or a redirection procedure. If the UE 704 is currently on an NR cell, the base station 702 may initiate a handover to a 5GC-connected E-UTRAN cell or a redirection to an E-UTRAN cell connected to the EPS 720. In the case of redirection, the base station 702 uses the security context provided by the AMF 714 to secure the procedure.

In this example, when the UE 704 needs to perform Emergency Services Fallback from 5G to 4G, the UE 704 transitions from the 5G Core Network (5GCN) 710 to the EPS 720, which includes an MME 724 that manages this transition on the 4G side.

In this example, the N26 interface is supported between the 5G AMF 714 and the 4G MME 724, the N26 interface allows for direct communication between these two core network elements, enabling efficient handover of UE context and security information. When the UE 704 falls back to 4G (S1 mode) and the N26 interface is supported, the UE 704 performs a Tracking Area Update (TAU) procedure with the MME 724. The UE 704 sets the active flag to ‘1’ in this TAU request, indicating to the MME 724 that it has pending data (in this case, an emergency call) to send. Upon receiving the TAU request, the MME 724 retrieves the UE's context from the AMF 714 via the N26 interface. This context includes security information, subscription data, and other relevant parameters needed to manage the UE in the 4G network.

If required, the MME 724 may initiate an EPS Authentication and Key Agreement (AKA) procedure with the UE 704. The MME 724 is responsible for validating the authentication response from the UE 704 and managing any authentication failures.

Once the TAU is complete and authentication is successful (if performed), the MME 724 is responsible for setting up the necessary bearers for emergency services. It coordinates with other EPS elements like the Serving Gateway (S-GW) and PDN Gateway (P-GW) to establish these bearers.

During these procedures, authentication maintains the security and integrity of the connection. However, authentication failures can occur, leading to potential disruptions in the ESF process.

Two primary problems related to authentication failures in ESF have been identified:
1. When the UE 704 is performing a 5GMM procedure for the emergency services fallback procedure and the authentication is rejected by the network, the UE's behavior may not be configured. This lack of clarity can lead to inconsistencies in how different UEs handle such failures, potentially impacting the reliability of emergency services.
2. When the UE 704 is performing a 5GMM procedure for the emergency services fallback procedure and the authentication fails on the UE side, the UE's behavior may also not configured. Similar to the first problem, this ambiguity can result in unpredictable behavior and potential delays in accessing emergency services.

These problems are further complicated when considering specific scenarios, such as authentication failures during a 5GS Mobility registration update procedure initiated for emergency services fallback. In such cases, the network may trigger an authentication procedure during the mobility registration update. However, the UE's behavior may not be configured when:
a) The network rejects the authentication challenge if the authentication response from the UE 704 is not valid. b)
b) The UE 704 rejects the authentication challenge sent by the network or deems that the network has failed the authentication check or assumes that the authentication is not genuine.
As a result, the UE 704 may be unable to complete the emergency services fallback procedure, potentially leaving the user without access to critical emergency services.

More specifically, during authentication procedures in both 5G and 4G networks, the network (AMF in 5G, MME in 4G) initiates and controls the authentication process. The UE 704 sends an authentication response to the network (AMF or MME). If the network cannot accept the authentication response from the UE (i.e., the response is not valid), it generates and sends an AUTHENTICATION REJECT message back to the UE. In particular, the AMF 714 in the 5GCN 710 generates and sends the AUTHENTICATION REJECT message. The MME 724 in the EPS 720 generates and sends the AUTHENTICATION REJECT message. This can occur during various procedures, including: Service request, mobility registration update, or initial registration procedures in 5G; and EMM attach, tracking area update, or service request procedures in 4G. For example, if the authentication response from the UE 704 is not valid, the MME 724 may send an AUTHENTICATION REJECT message to the UE 704. Further, the MME 724 may need to handle scenarios where the UE 704 rejects the authentication challenge or deems that the network has failed the authentication check.

In a first technique, when the UE 704 initiates a mobility registration update procedure in 5GS triggered by a request from upper layers for a pending emergency services fallback, it may encounter authentication failures. These failures can occur in two primary ways: either the network rejects the authentication response from the UE 704, or the UE 704 itself deems that the network has failed the authentication check.

In the case where the authentication response from the UE 704 cannot be accepted by the network, resulting in the UE 704 receiving an AUTHENTICATION REJECT message, the UE 704 may follow a specific set of actions. First, the UE 704 performs generic actions for authentication rejection as defined by network protocols. These actions typically involve updating the UE's internal state and clearing certain security parameters to maintain network integrity.

After completing the generic actions, the UE 704 has several options to pursue. One option is for the UE 704 to de-register locally from the current network without informing the network, and then attempt an initial registration specifically for emergency services. This approach allows the UE 704 to start fresh with a new registration attempt focused solely on obtaining emergency services.

Alternatively, the UE 704 may attempt to select an E-UTRA cell connected to either the EPS 720 or the 5GCN 710. This option enables the UE 704 to try accessing emergency services through a different radio access technology, potentially increasing the chances of successful connection.

In all cases, regardless of the specific action taken, the UE 704 may inform its upper layers about the authentication failure. This notification allows the upper layers of the UE 704 to invoke implementation-specific mechanisms for handling the emergency situation. For instance, the upper layers may decide to attempt the emergency call over a different IP Connectivity Access Network (IP-CAN), such as a Wi-Fi network if available.

In the scenario where the UE 704 cannot accept the authentication challenge from the network, or if the UE 704 deems that the network has failed the authentication check or assumes that the authentication is not genuine, the UE 704 may follow a similar but slightly different set of actions. First, the UE 704 performs generic actions for authentication failure as defined by network protocols.

Following these generic actions, the UE 704 takes more specific steps. It aborts the mobility registration update procedure, stops the timer T3510, and locally releases any resources allocated for the mobility registration update procedure. The UE 704 then enters the 5GMM-REGISTERED state.

After these steps, the UE 704 has similar options to those available in the case of network rejection. It may de-register locally and perform an initial registration for emergency services, or it may attempt to select an E-UTRA cell connected to the EPS 720 or the 5GCN 710. As before, in all cases, the UE 704 informs its upper layers about the failure.

In a second technique, when the UE 704 initiates a registration procedure or service request procedure for an emergency services fallback procedure and receives an AUTHENTICATION REJECT message from the network, the UE 704 follow a specific set of actions to handle the authentication failure while still attempting to access emergency services. The UE 704 first performs generic actions for authentication rejection as defined by network protocols. These actions typically involve updating the UE's internal state and clearing certain security parameters to maintain network integrity.

For instance, upon receiving an AUTHENTICATION REJECT message, the UE 704 sets its update status to 5U3 ROAMING NOT ALLOWED, indicating that it is not permitted to roam on the current network. It then deletes several key pieces of information from its memory, including the stored 5G-GUTI (Globally Unique Temporary Identifier), the TAI (Tracking Area Identity) list, the last visited registered TAI, and the ngKSI (Next Generation Key Set Identifier). This deletion of information is a security measure to prevent unauthorized access to the network using potentially compromised credentials.

After performing these generic actions, the UE 704 has several options to pursue, depending on the specific scenario and network environment. One option is for the UE 704 to de-register locally from the current network without informing the network, and then attempt an initial registration specifically for emergency services. This approach allows the UE 704 to start fresh with a new registration attempt focused solely on obtaining emergency services.

Alternatively, the UE 704 may attempt to select an E-UTRA cell connected to either the EPS 720 or the 5GCN 710. This option enables the UE 704 to try accessing emergency services through a different radio access technology, potentially increasing the chances of successful In all cases, regardless of the specific action taken, the UE 704 informs its upper layers about the authentication failure. This notification allows the upper layers of the UE 704 to invoke implementation-specific mechanisms for handling the emergency situation. For instance, the upper layers might decide to attempt the emergency call over a different IP Connectivity Access Network (IP-CAN), such as a Wi-Fi network if available, or over the Circuit Switched (CS) domain if the UE 704 supports legacy radio access technologies.

These actions apply not only when the UE 704 is attempting to register with a new PLMN after its home network becomes unavailable, but also when the UE 704 is in the same selected PLMN where the last service request procedure or mobility registration update procedure was attempted. This approach provides the UE 704 with multiple pathways to attempt establishing an emergency PDU session or PDN connection, even in the face of authentication challenges.

In scenarios where the UE 704 is performing a 5GMM procedure for emergency services fallback and encounters authentication failures due to that the UE 704 itself deems that the network has failed the authentication check, specific actions are required to maintain the possibility of accessing emergency services.

Authentication failures may be triggered by various causes. The UE 704 may detect a MAC failure (5GMM cause #20), indicating a message authentication code mismatch. Alternatively, the UE 704 may encounter a synchronization failure (5GMM cause #21), suggesting a sequence number discrepancy. The network may also reject the authentication as non-5G authentication unacceptable (5GMM cause #26), or the UE 704 may find that the ngKSI is already in use (5GMM cause #71). In some cases, the UE 704 may independently determine that the network has failed the authentication check based on its internal security algorithms.

Upon encountering any of these authentication failures, the UE 704 first performs generic actions for authentication failure as defined by network protocols. These actions typically involve updating the UE's internal state and clearing certain security parameters to maintain network integrity. For instance, the UE 704 may need to reset its security context or clear stored keys to prevent potential security breaches.

Following the generic actions, the UE 704 takes more specific steps to handle the emergency services fallback scenario. It aborts the mobility registration update procedure that was in progress, stops the timer T3510, and locally releases any resources that were allocated for the mobility registration update procedure. The UE 704 then enters the 5GMM-REGISTERED state, indicating that it maintains its registration with the network despite the authentication failure.

After these initial steps, the UE 704 has several options to pursue in its attempt to access emergency services. One option is for the UE 704 to de-register locally from the current network without informing the network, and then attempt an initial registration specifically for emergency services. This approach allows the UE 704 to start fresh with a new registration attempt focused solely on obtaining emergency services.

Alternatively, the UE 704 may attempt to select an E-UTRA cell connected to either the EPS 720 or the 5GCN 710. This option enables the UE 704 to try accessing emergency services through a different radio access technology, potentially increasing the chances of successful connection. The selection between EPS and 5GCN may depend on network availability and the UE's capabilities.

In all cases, regardless of the specific action taken, the UE 704 informs its upper layers about the authentication failure. This notification allows the upper layers of the UE 704 to invoke implementation-specific mechanisms for handling the emergency situation. For instance, the upper layers might decide to attempt the emergency call over a different IP Connectivity Access Network (IP-CAN), such as a Wi-Fi network if available. The procedures specified in 3GPP TS 24.229 provide guidelines for such alternative attempts, potentially allowing the emergency call to be made through another IP-CAN.

These actions apply not only when the UE 704 is attempting to register with a new PLMN after its home network becomes unavailable, but also when the UE 704 is in the same selected PLMN where the last service request procedure or mobility registration update procedure was attempted.

In one example, the UE 704 may perform mobility and periodic registration update procedures triggered by a request from upper layers to perform an emergency services fallback. When the UE 704 receives an AUTHENTICATION REJECT message from the AMF 714 during such procedures, the UE 704 may follow specific actions to handle the failure while still attempting to access emergency services. Initially, the UE 704 performs generic actions for authentication rejection as defined in subclauses 5.4.1.2.2.11, 5.4.1.2.3.1, 5.4.1.2.3A.1 or 5.4.1.3.5 of the 3GPP TS 24.501 specification. These actions typically involve updating the UE's internal state and clearing certain security parameters to maintain network integrity. For example, the UE 704 may set its update status to 5U3 ROAMING NOT ALLOWED, indicating that it is not permitted to roam on the current network, delete the stored 5G-GUTI, TAI list, last visited registered TAI and ngKSI.

After performing these generic actions, if the UE 704 additionally does not attempt to select an E-UTRA cell connected to EPC or 5GCN and the UE 704 is camped on an NR or E-UTRA cell connected to 5GCN in the same PLMN 710 where the last mobility and periodic registration update request was attempted, the UE 704 informs the upper layers of the failure of the procedure.

This notification to the upper layers allows for the implementation of specific mechanisms to handle the emergency situation. For example, procedures specified in 3GPP TS 24.229 may result in the emergency call being attempted over another IP Connectivity Access Network (IP-CAN). This could involve trying the emergency call over a Wi-Fi network if available, or attempting to use the Circuit Switched (CS) domain if the UE 704 supports legacy radio access technologies.

In another example, the UE 704 may initiate a service request procedure for emergency services fallback. This procedure is typically triggered when the UE 704 needs to transition from 5G (N1 mode) to 4 G (S1 mode) for emergency services, as indicated by the AMF 714 during the registration process.

The service request for emergency services fallback may encounter authentication challenges. If the AMF 714 sends an AUTHENTICATION REJECT message to the UE 704, the UE 704 may follow specific procedures to handle this rejection while still attempting to access emergency services. The UE 704 first performs the generic actions for authentication rejection as described in subclauses 5.4.1.2.2.11, 5.4.1.2.3.1, 5.4.1.2.3A.1 or 5.4.1.3.5 of the 3GPP TS 24.501 specification. These actions typically involve updating the UE's internal state and clearing certain security parameters to maintain network integrity.

After completing these initial procedures, the UE 704 evaluates its current situation. If the UE 704 does not attempt to select an E-UTRA cell connected to EPC or 5GCN, and is camped on an NR or E-UTRA cell connected to 5GCN in the same PLMN where the last service request was attempted, it takes further action. In this case, the UE 704 informs its upper layers about the failure of the service request procedure for emergency services fallback. This notification allows the upper layers of the UE 704 to invoke implementation-specific mechanisms for handling the emergency situation.

The upper layers, upon receiving this information, can initiate alternative procedures to attempt the emergency call through different means. As specified in 3GPP TS 23.167, the upper layers may request another emergency call attempt using domain selection. This could involve attempting the emergency call over a different radio access technology or even a different type of network.

For instance, the upper layers might decide to attempt the emergency call over the Circuit Switched (CS) domain if the UE 704 supports legacy radio access technologies like GSM or UMTS. Alternatively, they might try to establish the emergency call over a different IP Connectivity Access Network (IP-CAN), such as a Wi-Fi network if available.

In yet another example, authentication failures may occur is during the mobility and periodic registration update procedure triggered by a request from the upper layers to perform an emergency services fallback. If this procedure fails due to abnormal cases, or if it cannot be accepted or fails due to receiving an AUTHENTICATION REJECT message, the UE 704 may follow a specific set of actions.

In this example, if the UE 704 does not attempt to select an E-UTRA cell connected to EPC or 5GCN, and if the UE 704 is camped on an NR or E-UTRA cell connected to 5GCN in the same PLMN 710 where the last mobility and periodic registration update request was attempted, the UE 704 informs its upper layers of the failure of the procedure.

The abnormal cases may include one or more of cases that refer to specific authentication failure scenarios. One case corresponds to an authentication failure with 5GMM cause #20 “MAC failure”. This occurs when there is a message authentication code mismatch between the UE 704 and the network. Another case refers to an authentication failure with 5GMM cause #26 “non-5G authentication unacceptable”. Yet another case is related to an authentication failure with 5GMM cause #71 “ngKSI already in use”. Another case represents a scenario where the network fails the authentication check.

In these cases, the UE 704 follows a series of actions. During the abnormal cases described supra, if there is an emergency service started or ongoing, and if there is an ongoing registration procedure for mobility and periodic registration update triggered by a request from the upper layers to perform an emergency services fallback procedure, the UE 704 takes specific actions. For example, the UE 704 may abort the registration procedure for mobility and periodic registration update, stop timer T3510, locally release any resources allocated for the registration procedure for mobility and periodic registration update, and enter the state 5GMM-REGISTERED.

Following these actions, the UE 704 may attempt to select an E-UTRA cell connected to EPC or 5GCN according to the domain priority and selection rules specified in 3GPP TS 23.167. If the UE 704 finds a suitable E-UTRA cell, it proceeds with the appropriate EMM or 5GMM procedures.

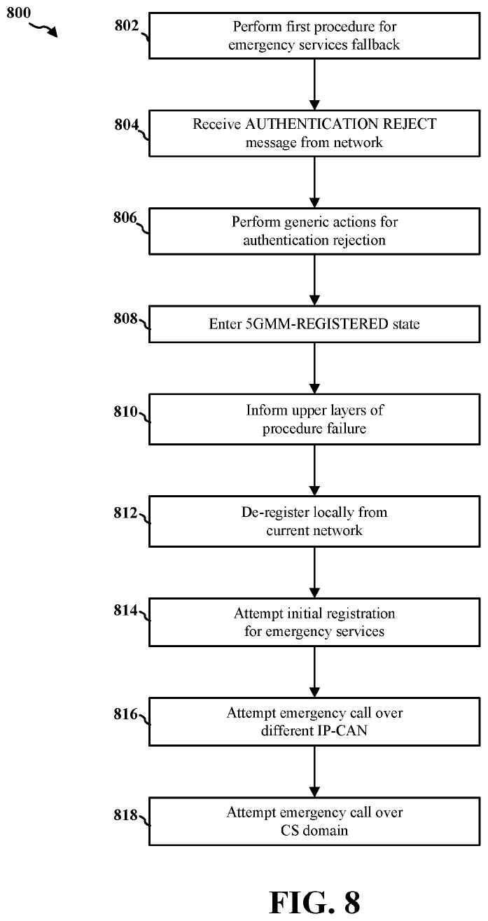

FIG. 8 is a flow chart 800 of a method for wireless communication for handling network authentication rejections during an emergency services fallback procedure. The method may be performed by a UE (e.g., the UE 704). In operation 802, the UE performs a first procedure for emergency services fallback. In certain configurations, the first procedure comprises a mobility and periodic registration update request triggered by a request from upper layers to perform the emergency services fallback. In certain configurations, the first procedure comprises a service request procedure for the emergency services fallback.

In operation 804, the UE receives an AUTHENTICATION REJECT message from a network during the first procedure. In operation 806, the UE performs generic actions for authentication rejection by the network. To perform the generic actions for authentication rejection, the UE sets an update status to ROAMING NOT ALLOWED, deletes stored identifiers including a 5G Globally Unique Temporary Identifier (5G-GUTI), a Tracking Area Identity (TAI) list, a last visited registered TAI, and a Next Generation Key Set Identifier (ngKSI).

In operation 808, the UE may enter a 5G Mobility Management (5GMM)-REGISTERED state after performing the generic actions for authentication rejection. In operation 810, the UE informs upper layers of a failure of the first procedure. In certain configurations, the upper layers are informed when the UE does not attempt to select an E-UTRA cell connected to an Evolved Packet System (EPS) or a 5G Core Network (5GCN) and is camped on a New Radio (NR) or E-UTRA cell connected to the 5GCN in a same Public Land Mobile Network (PLMN) where a last service request was attempted.

In operation 812, the UE de-registers locally from a current network without informing the network. In operation 814, the UE may attempt an initial registration specifically for emergency services. In operation 816, the UE may attempt an emergency call over a different IP Connectivity Access Network (IP-CAN). In operation 818, the UE may attempt an emergency call over a Circuit Switched (CS) domain if the UE supports legacy radio access technologies.

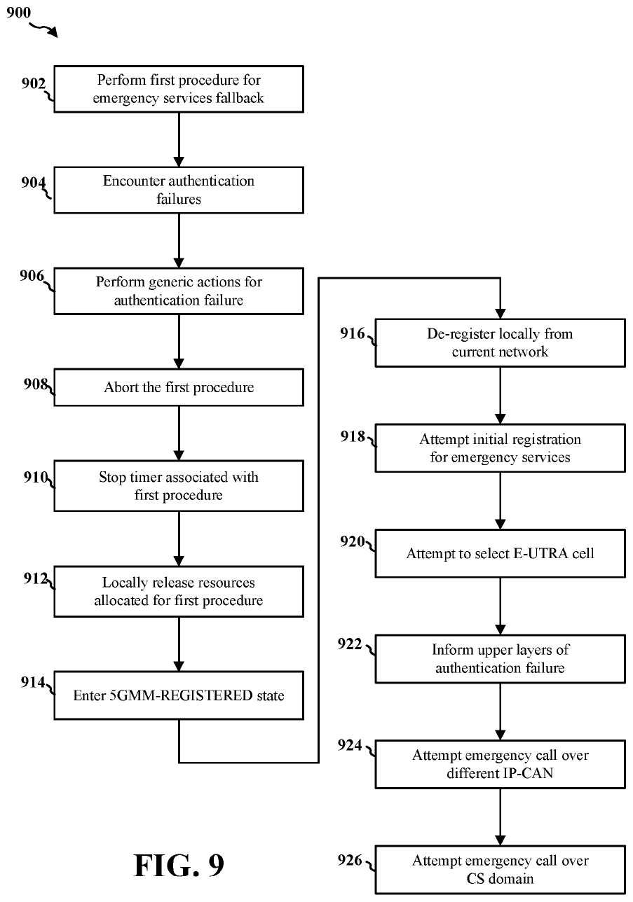

FIG. 9 is a flow chart 900 of a method for handling authentication failures during an emergency services fallback procedure. The method may be performed by a UE (e.g., the UE 704). In operation 902, the UE performs a first procedure for emergency services fallback. In certain configurations, the first procedure comprises a registration procedure for a mobility and periodic registration update.

In operation 904, the UE encounters authentication failures due to the UE deeming that a network has failed an authentication check. In certain configurations, the authentication failures are due to one or more of: a Message Authentication Code (MAC) failure, a synchronization failure, a non-5G authentication unacceptable, or a Next Generation Key Set Identifier (ngKSI) already in use.

In operation 906, the UE performs generic actions for authentication failure. In operation 908, the UE aborts the first procedure. In operation 910, the UE stops a timer associated with the first procedure. In operation 912, the UE locally releases any resources allocated for the first procedure.

In operation 914, the UE may enter a 5G Mobility Management (5GMM)-REGISTERED state after performing the generic actions for authentication failure. In operation 916, the UE de-registers locally from a current network without informing the network. In operation 918, the UE attempts an initial registration specifically for emergency services.

In operation 920, the UE may attempt to select an E-UTRA cell connected to either an Evolved Packet System (EPS) or a 5G Core Network (5GCN). In operation 922, the UE informs upper layers of the authentication failure. In operation 924, the UE may attempt an emergency call over a different IP Connectivity Access Network (IP-CAN). In operation 926, the UE may attempt an emergency call over a Circuit Switched (CS) domain if the UE supports legacy radio access technologies.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication for a User Equipment (UE), comprising:
performing a first procedure for emergency services fallback;
receiving an AUTHENTICATION REJECT message from a network during the first procedure; and
performing generic actions for authentication rejection by the network.

2. The method of claim 1, further comprising:
informing upper layers of a failure of the first procedure.

3. The method of claim 2, wherein the upper layers are informed when the UE does not attempt to select an E-UTRA cell connected to an Evolved Packet System (EPS) or a 5G Core Network (5GCN) and is camped on a New Radio (NR) or E-UTRA cell connected to the 5GCN in a same Public Land Mobile Network (PLMN) where a last service request was attempted.

4. The method of claim 1, wherein the first procedure comprises a mobility and periodic registration update request triggered by a request from upper layers to perform the emergency services fallback.

5. The method of claim 1, wherein the first procedure comprises a service request procedure for the emergency services fallback.

6. The method of claim 1, further comprising:
de-registering locally from a current network without informing the network; and
attempting an initial registration specifically for emergency services.

7. The method of claim 1, wherein the generic actions for authentication rejection include:
setting an update status to ROAMING NOT ALLOWED;
deleting stored identifiers including a 5G Globally Unique Temporary Identifier (5G-GUTI), a Tracking Area Identity (TAI) list, a last visited registered TAI, and a Next Generation Key Set Identifier (ngKSI).

8. The method of claim 1, further comprising:
attempting an emergency call over a different IP Connectivity Access Network (IP-CAN).

9. The method of claim 1, further comprising:
attempting an emergency call over a Circuit Switched (CS) domain if the UE supports legacy radio access technologies.

10. The method of claim 1, further comprising:
entering a 5G Mobility Management (5GMM)-REGISTERED state after performing the generic actions for authentication rejection.

11. A method of wireless communication for a User Equipment (UE), comprising:
performing a first procedure for emergency services fallback;
encountering authentication failures due to the UE deeming that a network has failed an authentication check; and
performing generic actions for authentication failure.

12. The method of claim 11, wherein the authentication failures are due to one or more of: a Message Authentication Code (MAC) failure, a synchronization failure, a non-5G authentication unacceptable, or a Next Generation Key Set Identifier (ngKSI) already in use.

13. The method of claim 11, further comprising:
aborting the first procedure;
stopping a timer associated with the first procedure; and
locally releasing any resources allocated for the first procedure.

14. The method of claim 11, wherein the first procedure comprises a registration procedure for a mobility and periodic registration update.

15. The method of claim 11, further comprising:
de-registering locally from a current network without informing the network; and
attempting an initial registration specifically for emergency services.

16. The method of claim 11, further comprising:
attempting to select an E-UTRA cell connected to either an Evolved Packet System (EPS) or a 5G Core Network (5GCN).

17. The method of claim 11, further comprising:
informing upper layers of the authentication failure.

18. The method of claim 11, wherein the UE enters a 5G Mobility Management (5GMM)-REGISTERED state after performing the generic actions for authentication failure.

19. The method of claim 11, further comprising:
attempting an emergency call over a different IP Connectivity Access Network (IP-CAN).

20. The method of claim 11, further comprising:
attempting an emergency call over a Circuit Switched (CS) domain if the UE supports legacy
